(19) United States
(12) Patent Application Publication
(10) Pub. No.: US 2009/0046848 A1
(43) Pub. Date: Feb. 19, 2009

(54) Encryption management system

(75) Inventor: Charles Booth, Vestal, NY (US)

Correspondence Address: TAROLLI, SUNDHEIM, COVELL & TUMMINO LLP, Suite 1700, 1300 East Ninth Street, Cleveland, OH, 44114, US

(73) Assignee: Lockheed Martin Corporation

(21) Appl. No.: 11/893,274

(22) Filed: Aug. 15, 2007

(51) Int. Cl. H04L 9/28

(52) U.S. Cl. 380/28

(57) ABSTRACT

Systems and methods are presented for increasing the security of transmitted message. A text selection component selects at least one portion of a document that contains sensitive information. A text extraction component extracts characters belonging to a selected character set from at least one selected portion of the document. An encryption interface provides the extracted characters to an encryption algorithm to provide an encrypted representation of the extracted characters. A document reconstruction component incorporates the encrypted representation of the extracted characters into the document to produce a reconstructed document in which the encrypted representation of the extracted characters replaces the extracted characters.

### FIELD OF THE INVENTION

The present invention is directed generally to digital representation of text and is particularly directed to an encryption management system to improve the security of encrypted text.

### BACKGROUND OF THE INVENTION

As increasing amounts of information are stored and transmitted digitally, it has become challenging to control access to confidential or otherwise sensitive information. To this end, a number of cryptographic algorithms have been established for the purpose of controlling access to sensitive data. Unfortunately, it is difficult, if not impossible, to design an encryption algorithm that is resilient to all forms of attack.

As the amount of processing power available at a reasonable cost grows, existing cryptographic schemes become even more vulnerable. In response, encryption schemes utilizing longer keys or multiple layers of encryption were developed, with the corresponding increase in the time and processing resources necessary to encrypt the data. While such algorithms are generally resistant to brute force decryption attempts, statistical analysis of encrypted data, in some circumstances, can lead an attacker to more efficient avenues of attack. Further, the application of most encryption schemes significantly changes the frequency with which certain characters appear in a document. This change in frequency can be detected by an automated system, signaling to an attacker that the document is encrypted and likely contains sensitive information.

### SUMMARY OF THE INVENTION

In accordance with one aspect of the present invention, an encryption management system is provided for increasing the security of transmitted message. A text selection component selects at least one portion of a document that contains sensitive information. A text extraction component extracts characters belonging to a selected character set from at least one selected portion of the document. An encryption interface provides the extracted characters to an encryption algorithm to provide an encrypted representation of the extracted characters. A document reconstruction component incorporates the encrypted representation of the extracted characters into the document to produce a reconstructed document in which the encrypted representation of the extracted characters replaces the extracted characters.

In accordance with another aspect of the present invention, a computer readable medium comprising a plurality of executable instructions is provided for securing information within a document. A text selection interface that allows a user to select at least one portion of a document. A text extraction component extracts characters from the selected at least one portion of the document in the form of raw text which omits spaces, punctuation, and formatting. An encryption interface provides the extracted raw text characters to an associated encryption algorithm to provide an encrypted representation of the raw text characters. A document reconstruction component incorporates the encrypted representation of the raw text characters into the document to produce a reconstructed document in which the encrypted representation of the raw text characters replaces the extracted raw text characters.

In accordance with yet another aspect of the present invention, a method is provided for increasing the security of a text document. At least one portion of a document that contains sensitive information is selected. Characters belonging to a selected character set are extracted from at least one selected portion of the document. The extracted characters are encrypted to provide an encrypted representation of the extracted characters. The document is reconstructed to incorporate the encrypted representation of the extracted characters in the place of the extracted characters such that a structure of the document is substantially unchanged.

### BRIEF DESCRIPTION OF THE DRAWINGS

The foregoing and other features of the present invention will become apparent to one skilled in the art to which the present invention relates upon consideration of the following description of the invention with reference to the accompanying drawings, wherein:

FIG. 1 illustrates an encryption management system for increasing the security of an encrypted text document;

FIG. 2 illustrates sequence of processing of an exemplary document using one implementation of an encryption management module in accordance with an aspect of the present invention;

FIG. 3 illustrates an exemplary communications system that utilizes an encryption management module in accordance with an aspect of the present invention;

FIG. 4 illustrates a methodology for illustrates an encryption management methodology is provided for increasing the security of a text document in accordance with an aspect of the present invention; and

FIG. 5 illustrates a computer system that can be employed to implement systems and methods described herein.

### DETAILED DESCRIPTION OF THE INVENTION

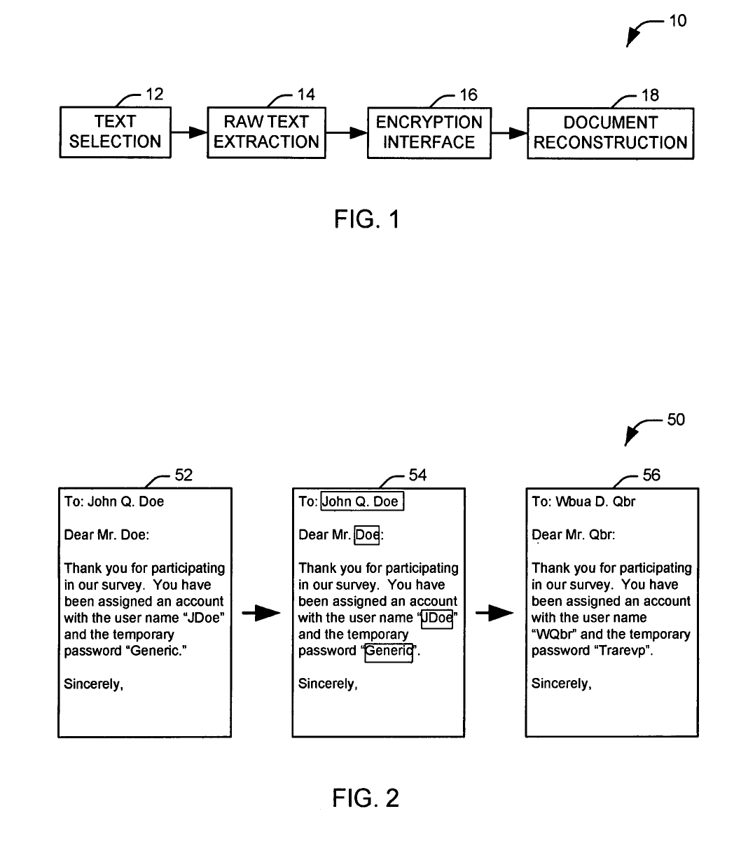

FIG. 1 illustrates an encryption management system 10 for increasing the security of an encrypted text document. The system 10 is designed to be modular, such that it can be implemented in an existing text based communications system, such as an e-mail client or a phone-based text messaging service, without modification. The system is also not specific to a given encryption algorithm and can be utilized in combination with any of a number of available encryption algorithms, including symmetric algorithms such as Triple DES (Data Encryption Standard) and AES (Advanced Encryption Standard), and asymmetric algorithms such as RSA and ElGamel.

A text document can be provided to a text selection component 12 that selects a portion of the text document that contains sensitive information. By sensitive information, it is meant personal or corporate information that, if revealed to an unauthorized party, could cause a risk of financial harm, legal liability, personal embarrassment, or other harm to the author of the text document or an affiliated organization or individual. Since many documents contain a mixture of sensitive and non-sensitive information, this selection will generally encompass a relatively small portion of the document. The text selection component 12 can include a user interface that allows a user to select sensitive portions of the document for encryption. As an alternative or a supplement to the user interface, the text selection component 12 can include an expert system that selects one or more sections of the document, for example, by locating key words or phrases in the document. Similarly, in documents that are structured to have defined fields, certain fields can be selected automatically.

The selected text sections are provided to a raw text extraction component 14 that extracts characters belonging to a selected character set from the selected text to produce a raw text representation of the data. For example, the selected character set may be limited to alphanumeric characters, such that punctuation, spaces, and formatting marks are not included in the raw text. Alternatively, the character set could be limited to letters, further excluding numbers from the text. It will be appreciated that the selected character set will vary with the application and the nature of the text document. In one implementation, the character set can be selected dynamically according to the content of the selected text portions.

The raw text is then encrypted at an encryption interface 16. The encryption interface 16 provides the raw text to an encryption algorithm associated with the text based communication system. The encryption algorithm then maps the characters comprising the raw text to a cipher text representation of the text utilizing the same character set and returns the encrypted text to the encryption management system. In one implementation, the character set can be divided into one or more subsets, such that each character within a first subset is mapped to a character within the first subset and each character within a second subset is mapped to a character within the second subset.

Each character comprising the raw text will have a corresponding character in the encrypted text. It will be appreciated that the encryption management system 10 is not dependent on any particular encryption algorithm. The system 10 can thus be incorporated into communication systems utilizing any of a number of encryption algorithms.

A document reconstruction component 18 reincorporates the encrypted raw text into the document. In accordance with an aspect of the present invention, each character of the encrypted text replaces its corresponding character in the raw text, keeping the basic structure of the document intact. For example, where the selected character set consists of the set of alphanumeric characters, neither the raw text nor the encrypted text would contain punctuation or spaces. Instead, the spacing and punctuation from the original document is retained, with the encrypted characters placed in the position of their corresponding raw text characters. The reconstructed document 18 can then be provided across a communications medium.

It will be appreciated that the encryption management system 10 protocol reduces the susceptibility of documents to statistical and brute force decryption techniques by reducing the sample of encrypted data available for analysis. Further, the system limits the encryption applied to a given document to those portions of the document that are sensitive, reducing any change in character frequencies from the substitution that might signal a would-be attacker that the document contain encrypted data. By limiting the available characters available in the selected character set, the impact of the encryption on character frequency can be further limited, making it even less likely that the encryption would be easily discoverable. In effect, the encrypted portion of the document is camouflaged as normal text.

FIG. 2 illustrates a sequence 50 of processing of an exemplary document 52 using one implementation of an encryption management module in accordance with an aspect of the present invention. At an intermediate stage 54, several portions of the document have been selected by one or both of a user or an automated system. The selected portions of the document represent sensitive information in the document, specifically a name, user name, and password of the recipient. The selected text is extracted from the document and encrypted to protect the sensitive information. In this example, a simple ROT-13 encryption is used to illustrate the concept, but it will be appreciated that in practice, more robust encryption algorithms can be utilized.

The encrypted text is then reincorporated into the original document to form a reconstructed document 56. In the reconstructed document 56, each character of the encrypted text is reinserted into the document in the place of its corresponding plain text character. The punctuation, spacing, and formatting, including capitalization, of the text is maintained, such that the basic structure of the message is unchanged and the ratio of special characters, such as spaces and punctuation marks, to text remains unchanged. Further, only the selected portion of the message is encrypted, allowing for a reduced impact on the frequency of individual letters. Accordingly, it will not immediately be apparent from a simple statistical analysis of the text that encrypted text, likely representing sensitive information, is present in the message.

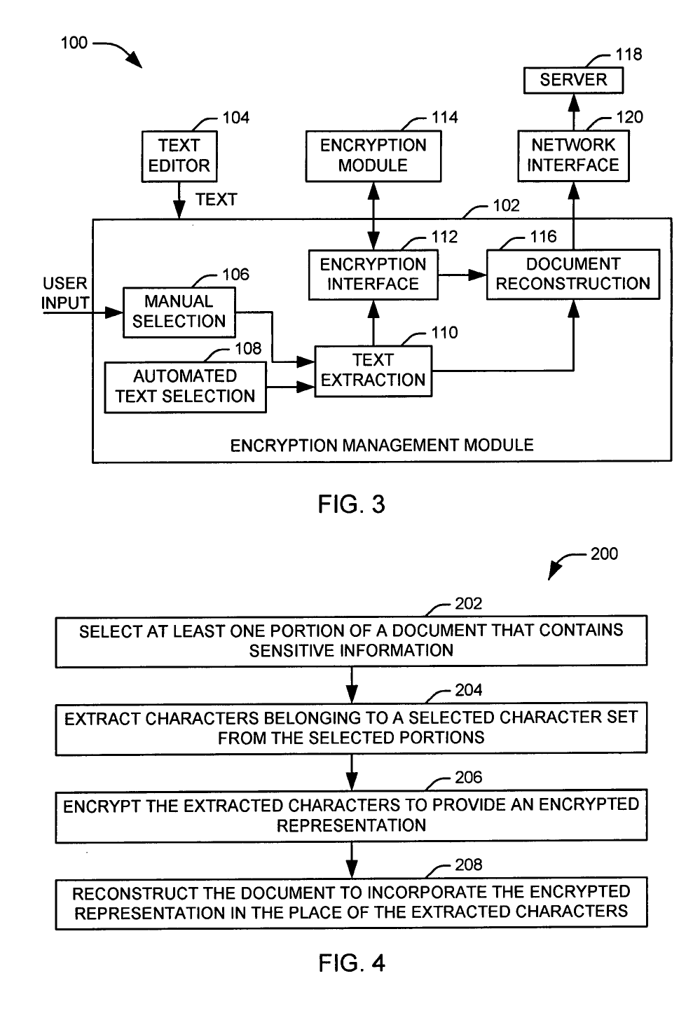

FIG. 3 illustrates an implementation of a communications system 100 that utilizes an encryption management module 102 in accordance with an aspect of the present invention. The messaging system 100 includes a text editor 104 where a user can compose a message to be transmitted. The composed text message can then be provided to the encryption management module 102 to begin the encryption process. A user can select one or portions of the text for encryption at a manual selection component 106. The manual selection component 106 provides a graphical user interface where the user can indicate portions of the text message that contain sensitive information. This interface can include any appropriate means for allowing the user to quickly and accurately select blocks of text.

An automated text selection component 108 can examine the document for certain words, phrases, or fields of interest and preselect a portion of the document for review by the user at the manual selection component 106 based upon any located words, phrases, and fields of interest. For example, the automated text selection component 108 can include a rule-based processor that locates words, combinations of words in proximity, or formatting that suggests the presence of sensitive information. The addition of the automated component facilitates user compliance in the protection of sensitive information by ensure that certain categories of common information are protected by default.

The selected text is extracted from the message at a text extraction component 110. The text extraction component 110 removes all characters from a predefined character set from the selected text, leaving behind the characters not belonging to the predefined set in an unencrypted portion of the document. It will be appreciated that the selected text is extracted as a raw text representation, with no formatting and no characters from outside of the predefined set. For example, the predefined character set can include all alphanumeric characters, such that spaces and punctuation are retained in the unencrypted portion of the text. Alternatively, the predefined character set can include only the set of all letters, leaving numbers in the unencrypted text as well. In one implementation, the letters are extracted independently of capitalization, such that an extracted capital “L” is equivalent to an extracted lowercase “l”. In this implementation, the capitalization structure of the selected text is retained as formatting. It will be appreciated that the predefined character set will vary with the application and the nature of the sensitive information intended to be protected.

The extracted text is then provided to an encryption interface 112 that operates in conjunction with an external encryption module 114 to encrypt the extracted text. Specifically, the encryption interface 112, in conjunction with the encryption module, conducts a letter by letter mapping of the extracted text to letters within the selected character set to produce an encrypted cipher text. To facilitate this encryption, one of the encryption interface 112 and the encryption module 114 can include a configuration file (not shown) containing the predefined character set. In-one implementation, the character set can be divided into one or more subsets, such that each character within a first subset is mapped to a character within the first subset and each character within a second subset is mapped to a character within the second subset.

Once the extracted text has been encrypted, the encrypted text is reincorporated into the original document at a document reconstruction component 116. At the document reconstruction component, each letter of the encrypted text is reinserted into the position occupied by its corresponding plain text character. The formatting, punctuation, and spacing are maintained, so the structure of the document is essentially unchanged. As mentioned previously, in one implementation, the retained formatting can include the case of each letter, such that the original pattern of capitalization among the characters is maintained. The reconstructed document is then provided to an exchange server 118 via a network interface 120 associated with the text messaging system for transmission across a communications network to a recipient.

In view of the foregoing structural and functional features described above, methodologies in accordance with various aspects of the present invention will be better appreciated with reference to FIG. 4. While, for purposes of simplicity of explanation, the methodology of FIG. 4 is shown and described as executing serially, it is to be understood and appreciated that the present invention is not limited by the illustrated order, as some aspects could, in accordance with the present invention, occur in different orders and/or concurrently with other aspects from that shown and described herein. Moreover, not all illustrated features may be required to implement a methodology in accordance with an aspect the present invention.

FIG. 4 illustrates an encryption management methodology 200 is provided for increasing the security of a text document in accordance with an aspect of the present invention. At step 202, at least one portion of a document that contains sensitive information is selected. The document portions can be selected by one or both of a user or an automated system. At step 204, characters belonging to a selected character set are extracted from at least one selected portion of the document. For example, the selected character set can include all alphanumeric characters, the set of all lowercase letters, or a similarly limited character set.

At step 206, the extracted characters are encrypted to provide an encrypted representation of the extracted characters. This encryption can comprise a one-to-one mapping of each extracted character to a character within the selected character set. In one implementation, the selected character set can be divided into multiple character subsets, which each extracted character mapped to a character from the subset to which it belongs. The document is reconstructed at step 208 to incorporate the encrypted representation of the extracted characters in the place of the extracted characters such that a structure of the document is substantially unchanged.

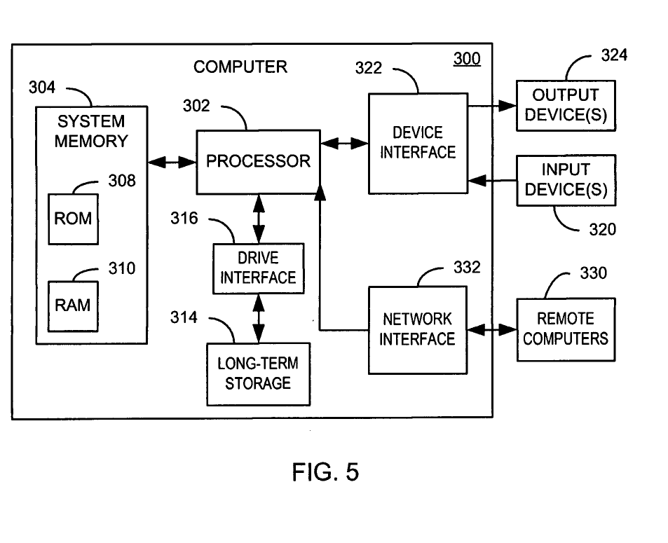

FIG. 5 illustrates a computer system 300 that can be employed to implement systems and methods described herein, such as based on computer executable instructions running on the computer system. The computer system 300 can be implemented on one or more general purpose networked computer systems, embedded computer systems, routers, switches, server devices, client devices, various intermediate devices/nodes and/or stand alone computer systems. Additionally, the computer system 300 can be implemented as part of the computer-aided engineering (CAE) tool running computer executable instructions to perform a method as described herein.

The computer system 300 includes a processor 302 and a system memory 304. Dual microprocessors and other multi-processor architectures can also be utilized as the processor 302. The processor 302 and system memory 304 can be coupled by any of several types of bus structures, including a memory bus or memory controller, a peripheral bus, and a local bus using any of a variety of bus architectures. The system memory 304 includes read only memory (ROM) 308 and random access memory (RAM) 310. A basic input/output system (BIOS) can reside in the ROM 308, generally containing the basic routines that help to transfer information between elements within the computer system 300, such as a reset or power-up.

The computer system 300 can include one or more types of long-term data storage 314, including a hard disk drive, a magnetic disk drive, (e.g., to read from or write to a removable disk), and an optical disk drive, (e.g., for reading a CD-ROM or DVD disk or to read from or write to other optical media). The long-term data storage can be connected to the processor 302 by a drive interface 316. The long-term storage components 314 provide nonvolatile storage of data, data structures, and computer-executable instructions for the computer system 300. A number of program modules may also be stored in one or more of the drives as well as in the RAM 310, including an operating system, one or more application programs, other program modules, and program data.

A user may enter commands and information into the computer system 300 through one or more input devices 320, such as a keyboard or a pointing device (e.g., a mouse). These and other input devices are often connected to the processor 302 through a device interface 322. For example, the input devices can be connected to the system bus 306 by one or more a parallel port, a serial port or a universal serial bus (USB). One or more output device(s) 324, such as a visual display device or printer, can also be connected to the processor 302 via the device interface 322.

The computer system 300 may operate in a networked environment using logical connections (e.g., a local area network (LAN) or wide area network (WAN) to one or more remote computers 330. The remote computer 330 may be a workstation, a computer system, a router, a peer device or other common network node, and typically includes many or all of the elements described relative to the computer system 300. The computer system 300 can communicate with the remote computers 330 via a network interface 332, such as a wired or wireless network interface card or modem. In a networked environment, application programs and program data depicted relative to the computer system 300, or portions thereof, may be stored in memory associated with the remote computers 330.

It will be understood that the above description of the present invention is susceptible to various modifications, changes and adaptations, and the same are intended to be comprehended within the meaning and range of equivalents of the appended claims. The presently disclosed embodiments are considered in all respects to be illustrative, and not restrictive. The scope of the invention is indicated by the appended claims, rather than the foregoing description, and all changes that come within the meaning and range of equivalence thereof are intended to be embraced therein.

Having described the invention, we claim the following:

1. An encryption management system for increasing the security of transmitted message, comprising:
a text selection component that selects at least one portion of a document that contains sensitive information;
a text extraction component that extracts characters belonging to a selected character set from at least one selected portion of the document;
an encryption interface that provides the extracted characters to an encryption algorithm to provide an encrypted representation of the extracted characters; and
a document reconstruction component that incorporates the encrypted representation of the extracted characters into the document to produce a reconstructed document in which the encrypted representation of the extracted characters replaces the extracted characters.

2. The system of claim 1, the text selection component comprising a user interface that allows a user to select the at least one portion of the document.

3. The system of claim 1, the text selection component comprising a rule-based processor that examines the document for at least one of words, phrases, and fields associated with sensitive information.

4. The system of claim 1, the selected character set consisting of alphanumeric characters.

5. The system of claim 4, the selected character set consisting of numbers and lowercase letters.

6. The system of claim 1, wherein the encrypted representation of the extracted characters represents a character by character substitution of the extracted characters, such that each extracted character has a corresponding character in the encrypted representation.

7. The system of claim 6, wherein the selected character set comprises a plurality of character subsets, and each character in the extracted characters belonging to a given character subset will have a corresponding encrypted character within the character subset.

8. The system of claim 7, wherein the document reconstruction component incorporates each character in the encrypted representation into a position within the document associated with its corresponding extracted character.

9. The system of claim 8, wherein a case of each of a plurality of letters in the extracted characters is recorded and provided to the document reconstruction component, and the document reconstruction component reconstructs the document such that each letter in the encrypted representation retains the case of its associated extracted character.

10. A communications system, comprising:
a text editor that allows a user to compose a text message;
an encryption module that is operative to encrypt text within the text message via an associated encryption algorithm;
the encryption management system of claim 1; and
a network interface that interfaces with a communications network to transmit the reconstructed document from the encryption management system.

11. A computer readable medium comprising a plurality of executable instructions for securing information within a document, the executable instructions comprising:
a text selection interface that allows a user to select at least one portion of a document;
a text extraction component that extracts characters from the selected at least one portion of the document in the form of raw text which omits spaces, punctuation, and formatting;
an encryption interface that provides the extracted raw text characters to an associated encryption algorithm to provide an encrypted representation of the raw text characters; and
a document reconstruction component that incorporates the encrypted representation of the raw text characters into the document to produce a reconstructed document in which the encrypted representation of the raw text characters replaces the extracted raw text characters.

12. The computer readable medium of claim 11, further comprising an automated selection component that examines the document for at least one of words, phrases, and fields associated with sensitive information.

13. The computer readable medium of claim 11, wherein the encrypted representation of the raw text characters represents a character by character substitution of the raw text characters, such that each extracted raw text character has a corresponding character in the encrypted representation and the document reconstruction component incorporates each character in the encrypted representation into a position within the document associated with its corresponding extracted raw text character.

14. The computer readable medium of claim 13, wherein the selected character set comprises a plurality of character subsets, and each character in the extracted raw text characters belonging to a given character subset will have a corresponding encrypted character within the character subset.

15. A method for increasing the security of a text document, comprising:
selecting at least one portion of a document that contains sensitive information;
extracting characters belonging to a selected character set from at least one selected portion of the document;
encrypting the extracted characters to provide an encrypted representation of the extracted characters; and
reconstructing the document to incorporate the encrypted representation of the extracted characters in the place of the extracted characters such that a structure of the document is substantially unchanged.

16. The method of claim 15, wherein selecting at least one portion of a document that contains sensitive information comprises selection of at least one portion of the document by a user.

17. The method of claim 15, wherein encrypting the extracted characters to provide an encrypted representation of the extracted characters comprises a one-to-one mapping of extracted characters to encrypted characters, such that each extracted raw text character has a corresponding character in the encrypted representation, and reconstructing the document comprises incorporating each character in the encrypted representation into a position within the document associated with its corresponding extracted raw text character.

18. The method of claim 17, wherein the selected character set comprises a plurality of character subsets, and each character in the extracted characters belonging to a given character subset is mapped corresponding encrypted character within the character subset.

19. The method of claim 16, the selected character set consisting of alphanumeric characters.

20. The method of claim 16, wherein selecting at least one portion of a document that contains sensitive information comprises examining the document via an automated system for at least one of words, phrases, and fields associated with sensitive information.
